(19) United States
(12) Patent Application Publication
(10) Pub. No.: US 2025/0378572 A1
(43) Pub. Date: Dec. 11, 2025

(54) SHARED COORDINATE SPACE

(71) Applicant: Apple Inc., Cupertino, CA (US)

(72) Inventors: Christian Lipski, Cupertino, CA (US); Benzun Pious Wisely Babu, San Jose, CA (US); Amy R. Kawabata, Walnut Creek, CA (US); Andrew G. Ward, Sunnyvale, CA (US); Jai Prakash, San Jose, CA (US); Lei Zhou, Sunnyvale, CA (US)

(21) Appl. No.: 19/223,705

(22) Filed: May 30, 2025

Related U.S. Application Data
(60) Provisional application No. 63/657,502, filed on Jun. 7, 2024.

(51) Int. Cl. G06T 7/70; G06T 7/579; G06T 7/80; H04N 23/90

(52) U.S. Cl. CPC G06T 7/70; G06T 7/579; G06T 7/80; H04N 23/90

(57) ABSTRACT

Various implementations disclosed herein include devices, systems, and methods that uses image and sensor data to generate a standard-format stage anchor map identifying positions of elements of a 3D scene. For example, an example process may include obtaining image data and camera data from one or more cameras of an electronic device while the electronic device is within a three-dimensional (3D) environment. The process may further include converting the image data and camera data into a first data set having a first format specified by a map-generation process. The process may further include generating a stage anchor map by inputting the first data set into the map-generation process. The stage anchor map may identify positions of anchors corresponding to elements of the 3D environment. Likewise, the stage anchor map may be used to localize a plurality of camera devices capturing images of the 3D environment during a filming session.

### CROSS-REFERENCE TO RELATED APPLICATIONS

This application claims the benefit of U.S. Provisional Application Ser. No. 63/657,502 filed Jun. 7, 2024, which is incorporated herein in its entirety.

### TECHNICAL FIELD

The present disclosure generally relates to systems, methods, and devices that that use image and sensor data to generate a standard-format stage anchor map identifying positions of elements of a three-dimensional (3D) scene.

### BACKGROUND

Existing localization systems may be improved with respect to standardization, security, and accuracy.

### SUMMARY

Various implementations disclosed herein include systems, methods, and devices that use image and sensor data to generate a stage anchor map comprising a standard-format for use via multiple differing devices that may be associated with different types of sensors, different operating systems, different captured-image formats, etc. In some implementations, a stage anchor map may identify positions of elements of a 3D scene (e.g., an extended reality (XR) environment) such as, inter alia, stage anchors.

In some implementations, multiple recording devices (e.g., multiple different camera devices) may be localized within a 3D scene during a filming session by comparing sensor data of the multiple recording devices to a map of the 3D scene. In some implementations, a map of a 3D scene may be generated based on data such as image data captured by a device. The captured data may be converted to an intermediate standardized format and a process such as an application programming interface (API) may be used to convert the intermediate format data into a final standardized format such as, for example, a simultaneous localization and mapping (SLAM) map that identifies stage anchors. In some implementations, the intermediate format data may include image data, camera data, or any other data usable by the API to determine 3D locations of stage anchors based on images from a camera. In some implementations, image data may include, inter alia, RGB data, greyscale data, depth data, etc. In some implementations, camera data may include, inter alia, a position or rotation of a camera for each picture, camera information such as a fish-eye perspective image, distortion, etc.

In some implementations, a final stage anchor map may be generated such that it does not include (and is not based on) a 3D mapping of an image capturing device and therefore does not expose (to other devices) the image capturing device's platform's 3D information or processes. Therefore, the image capturing device will only produce intermediate data captured by an API to convert the intermediate data into final, sharable mapping data used for localization.

In some implementations, an electronic device has one or more cameras and a processor (e.g., one or more processors) that executes instructions stored in a non-transitory computer-readable medium to perform a method. The method performs one or more steps or processes. In some implementations, the electronic device obtains image data and camera data from a plurality of cameras while the electronic device is within a three-dimensional (3D) environment. In some implementations, the image data and camera data may be converted into a first data set having a first format. The first format may be specified by a map-generation process. In some implementations, a stage anchor map may be generated by inputting the first data set into the map-generation process such that the stage anchor map identifies positions of anchors corresponding to elements of the 3D environment. In some implementations, the stage anchor map may be used to localize a plurality of camera devices capturing images of the 3D environment during a filming session.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-B illustrate exemplary electronic devices operating in a physical environment, in accordance with some implementations.

FIG. 2 illustrates an example environment, in accordance with some implementations.

FIG. 3 illustrates multiple differing views of a physical environment used to generate a standardized map usable by each recording device for localization, in accordance with some implementations.

FIG. 4 illustrates a view of a physical environment with tags identifying stage anchors representing objects and associated locations in a physical environment, in accordance with some implementations.

FIG. 5 illustrates an example environment for implementing a process for generating a standard-format stage anchor map identifying positions of elements of a 3D scene, in accordance with some implementations.

FIG. 6 is a flowchart representation of an exemplary method that uses image and sensor data to generate a standard-format stage anchor map identifying positions of elements of a 3D scene, in accordance with some implementations.

FIG. 7 is an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

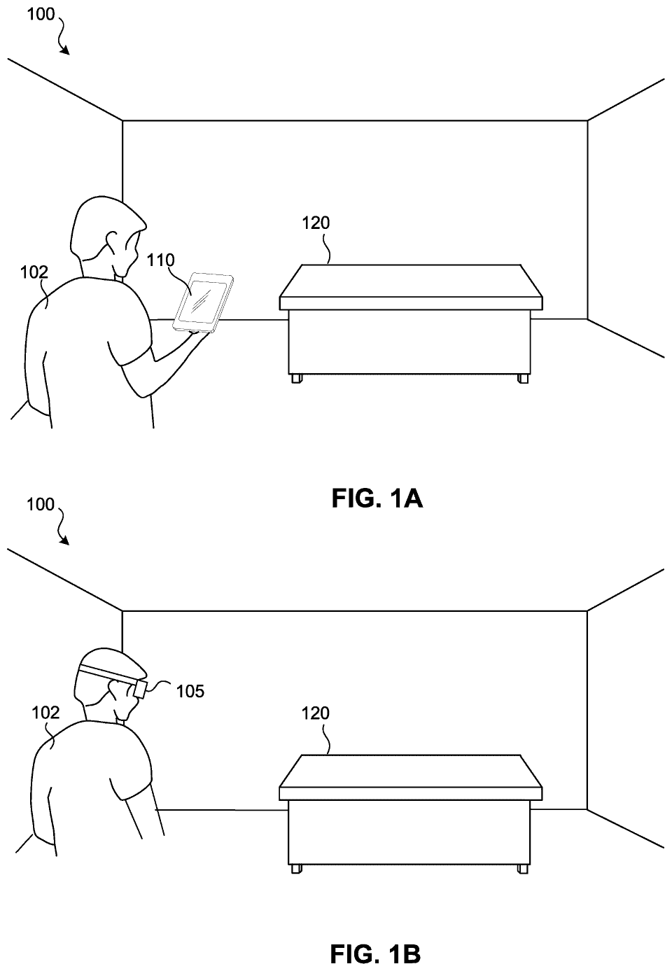

FIGS. 1A-B illustrate exemplary electronic devices 105 and 110 operating in a physical environment 100. In the example of FIGS. 1A-B, the physical environment 100 is a room that includes a desk 120. The electronic devices 105 and 110 may include one or more cameras, microphones, depth sensors, or other sensors that can be used to capture information about and evaluate the physical environment 100 and the objects within it, as well as information about the user 102 of electronic devices 105 and 110. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown) via electronic devices 105 (e.g., a wearable device such as an HMD) and/or 110 (e.g., a handheld device such as a mobile device, a tablet computing device, a laptop computer, etc.). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100.

In some implementations, a standard-format stage anchor map may be generated using image and sensor data. The standard-format stage anchor map may be configured to identify positions of elements of a 3D scene (e.g., stage anchors).

In some implementations, image data and camera data may be obtained from cameras while an electronic device (e.g., electronic device 105 and/or 110) is within a three-dimensional (3D) environment. The image data and camera data may be converted into a first data set comprising a first format specified by a map-generation process such as a map-generation API.

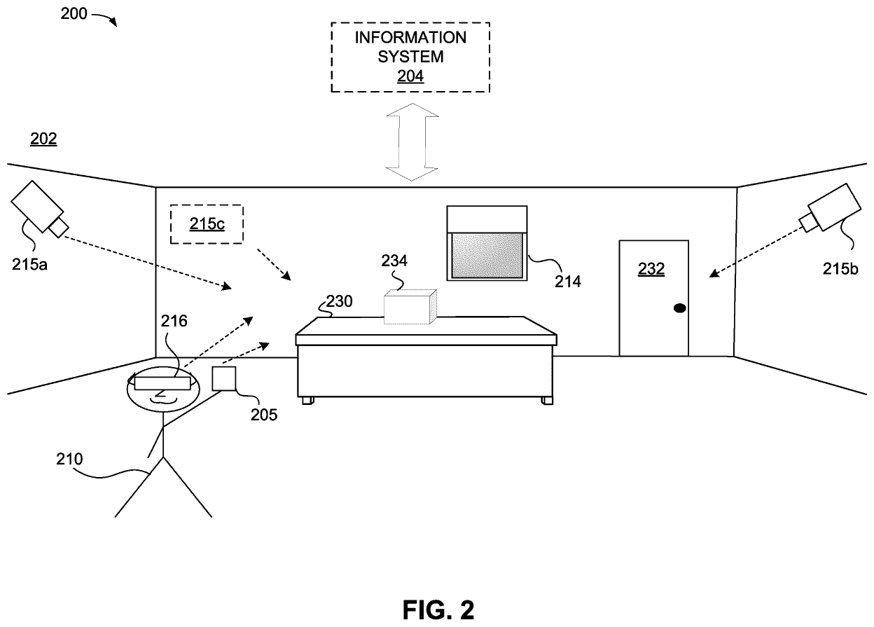

In some implementations, a stage anchor map may be generated by inputting the first data set into the map-generation process. The stage anchor map may be configured to identify positions of anchors such as objects or SLAM features corresponding to elements of the 3D environment. In some implementations, the stage anchor map may be used to localize a plurality of camera devices capturing images of the 3D environment during a filming session as further described with respect to FIG. 2, infra.

FIG. 2 illustrates an example environment 200 of exemplary electronic devices 205, 215a, 215b, 215c and 216 (e.g., a wearable device) operating in a physical environment 202. Additionally, example environment 200 may include an information system 204 (e.g., a framework, server, controller or network) in communication with one or more of the electronic devices 205, 215a, 215b, 215c and 216. In an exemplary implementation, electronic devices 205, 215a, 215b, 215c, and 216 are communicating with each other and an intermediary device such as information system 204. In some implementations, electronic devices 205, 215a, 215b, 215c and 216 may include at least two of mobile devices, tablet devices, HMDs, stand-alone video camera devices, wall-mounted camera devices, etc.

In some implementations, physical environment 202 includes a user 210 holding electronic device 205 and wearing electronic device 216. In some implementations, electronic device 216 comprises a wearable device (e.g., a head mounted display (HMD) configured to present views of an extended reality (XR) environment (e.g., a 3D scene), which may be based on the physical environment 202, and/or include added content such as virtual objects.

In the example of FIG. 2, the physical environment 202 may be a room that includes physical objects such as a desk 130, a window 214, and a door 132. In some implementations, the physical environment 202 is a part of an XR environment presented by, for example, electronic device 216. In this instance, desk 130, window 214, door 132, and/or object 234 may be physical objects or virtual objects.

In some implementations, each electronic device 205, 215a, 215b, 215c and 216 may include one or more cameras, microphones, depth sensors, motion sensors, optical sensors or other sensors that can be used to capture information about and evaluate the physical environment 202 or XR environment and the objects within it, as well as information about user 210. Each electronic device 205, 215a, 215b, 215c and 216 may comprise a plurality of electronic devices.

In some implementations, information such as image or sensor data about the physical environment 202 and/or XR environment (e.g., a 3D scene) may be obtained from electronic devices 205, 215a, 215b, 215c and 216. The image or sensor data may be used to generate a standard-format stage anchor map identifying positions of physical or virtual objects, such as desk 230 and/or object 234 of a 3D scene (e.g., stage anchors).

In some implementations, each of electronic devices 205, 215a, 215b, 215c and 216 may include recording devices (e.g., multiple different cameras) that are localized within a 3D scene during a filming session. For example, electronic devices 205, 215a, 215b, 215c and 216 may be localized within a 3D scene during a filming session by comparing captured sensor data (e.g., images) obtained from each of electronic devices 205, 215a, 215b, 215c and 216 to a map of the 3D scene. Subsequently, the captured sensor data may be converted into an intermediate standardized format usable by each of electronic devices 205, 215a, 215b, 215c and 216. In some implementations, a process such as a specialized (API) may be used to convert the intermediate standardized format sensor data into a final standardized format such as, for example, a simultaneous localization and mapping (SLAM) map that identifies stage anchors.

In some implementations, the intermediate standardized format sensor data may include image data, camera data, or any other data type usable by an API to determine 3D locations of stage anchors within the 3D environment. In some implementations, image data may include, inter alia, RGB data, greyscale data, depth data, etc. In some implementations, camera data may include, inter alia, a position or rotation attribute of a camera for each image. In some implementations, camera data may include, inter alia, camera information such as a fish-eye perspective image, distortion, etc.

In some implementations, a final stage anchor map may be generated without a 3D mapping of a device capturing an image thereby preventing exposure of the image capturing device's platform's (e.g., operating system), 3D information, or processes. Therefore, the image capturing device will only produce intermediate data captured by an API to convert the intermediate data into final, sharable generic mapping data used for localization.

In some implementations, an electronic device (e.g., electronic device 216) may distribute the final, sharable generic mapping data (e.g., a stage anchor map) to each of electronic devices 205, 215a, 215b, and 215c to be used by applications of the plurality of camera devices. For example, applications of electronic devices 205, 215a, 215b, and 215c may enable a process for querying the final, sharable generic mapping data to, inter alia, generate a SLAM map identifying stag) anchors to perform a localization process for localizing each of electronic devices 205, 215a, 215b, and 215c, obtain light probes, upload information to the final, sharable generic mapping data for updates, etc.

In the example of FIG. 2, electronic device 205 is illustrated as a hand-held device. Electronic device 205 may be a mobile phone, a tablet, a laptop, etc. In some implementations, electronic device 216 comprises a wearable device be worn by a user. For example, electronic device 216 may be a head-mounted device (HMD), a smart watch, a smart bracelet, a smart ring, a smart patch, an ear/head mounted speaker, etc.

In some implementations, electronic devices 215a, 215b, and 215c each comprise a video retrieval device such as, inter alia, a camera capable of capturing a live motion image of (a portion of) physical environment 202 or a still image of (a portion of) physical environment 202.

In some implementations, functions of the electronic devices 205, 215a, 215b, 215c and 216 are accomplished via two or more devices, for example a mobile device and a camera or a head mounted device and a camera. Various capabilities may be distributed amongst multiple devices, including, but not limited to power capabilities, CPU capabilities, GPU capabilities, storage capabilities, memory capabilities, visual content display capabilities, audio and/or video content production capabilities, etc. The multiple devices that may be used to accomplish the functions of electronic devices 205, 215a, 215b, 215c and 216 may communicate with one another via wired or wireless communications. In some implementations, each device communicates with a separate controller or server to manage and coordinate an experience for the user (e.g., information system 204). Such a controller or server may be located in or may be remote relative to the physical environment 202.

According to some implementations, the electronic devices (e.g., electronic devices 205, 215a, 215b, 215c, and 216) can generate and present an extended reality (XR) environment. In contrast to a physical environment that people can sense and/or interact with without aid of electronic devices, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

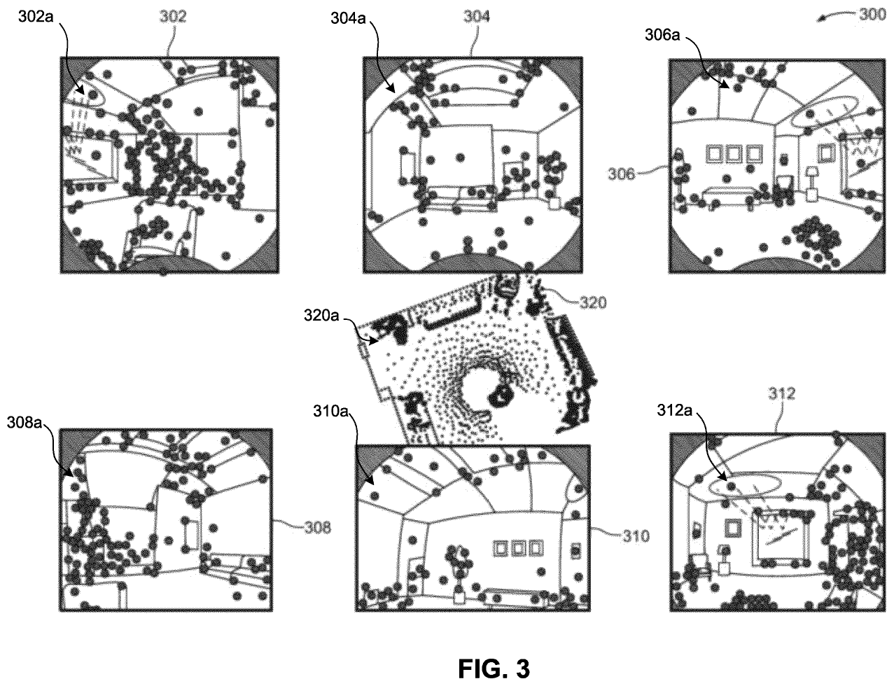

FIG. 3 illustrates multiple differing views 302, 304, 306, 308, 310, and 312 of a physical environment 300 used to generate a standardized map 320 usable by each recording device (e.g., camera) for localization, in accordance with some implementations. Each of views 302, 304, 306, 308, 310, and 312 includes a plurality of stage anchors 302a, 304a, 306a, 308a, 310a, and 312a (e.g., represented by circles) representing locations of objects (physical and/or virtual) of physical environment 300. For example, view 302 includes a plurality of stage anchors 302a representing locations of objects from a perspective of view 302. Likewise, view 304 includes a plurality of stage anchors 304a representing locations of objects from a perspective of view 304, view 306 includes a plurality of stage anchors 306a representing locations of objects from a perspective of view 306, view 308 includes a plurality of stage anchors 308a representing locations of objects from a perspective of view 308, view 310 includes a plurality of stage anchors 310a representing locations of objects from a perspective of view 310, and view 312 includes a plurality of stage anchors 312a representing locations of objects from a perspective of view 312. In some implementations, stage anchors 302a, 304a, 306a, 308a, 310a, and 312a are used to generate standardized map 320 comprising stage anchors 320a to be converted (e.g., via a common API) into a final standard format such as, inter alia, a SLAM map identifying stage anchors 320a enabling a process for localizing each recording device such as, for example, electronic devices 205, 215a, 215b, 215c, and 216 of FIG. 2.

In some implementations, each of views 302, 304, 306, 308, 310, and 312 of physical environment 300 may be generated by a differing camera (e.g., electronic devices 205, 215a, 215b, 215c, and 216 of FIG. 2) within physical environment 300. Subsequently, each of views 302, 304, 306, 308, 310, and 312 are converted into standardized map 320 comprising stage anchors 320a (i.e., a shared base map usable by multiple different types of devices) to be loaded on each of, for example, electronic devices 205, 215a, 215b, 215c, and 216 of FIG. 2. The standardized map 320 enables electronic devices 205, 215a, 215b, 215c, and 216 devices, comprising differing device types, differing operating systems, differing platforms, differing 3D information, etc., to synchronize their positions or localize their positions within an environment.

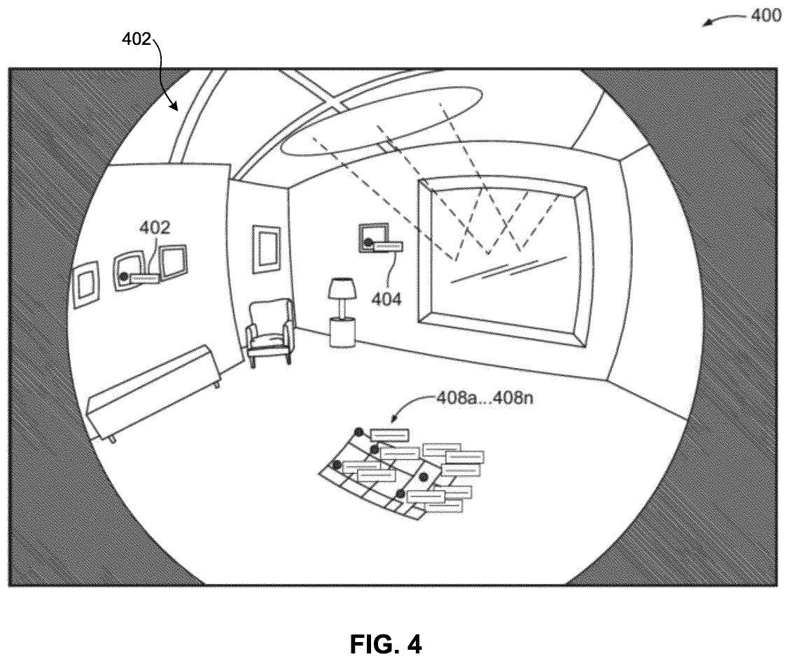

FIG. 4 illustrates a view 400 of a physical environment 402 with tags 402, 404, and 408a . . . 408n identifying stage anchors representing objects (physical and virtual) and associated locations in physical environment 400, in accordance with some implementations. View 400 represents a standardized map 320 usable by each recording device (e.g., electronic devices 205, 215a, 215b, 215c, and 216 of FIG. 2) for localization. View 400 includes tags 402, 404, and 408a . . . 408n identifying stage anchors representing locations of objects from a perspective of view 306 of FIG. 3.

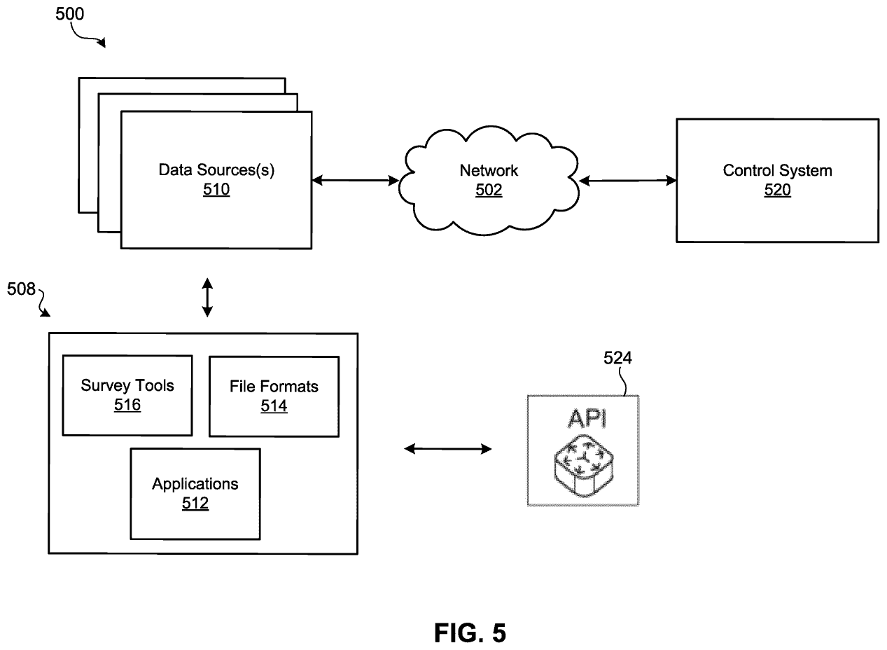

FIG. 5 illustrates an example environment 500 for implementing a process for generating a standard-format stage anchor map identifying positions of elements of a 3D scene, in accordance with some implementations. The example environment 500 includes data sources 510 (e.g., cameras such as electronic devices 205, 215a, 215b, 215c, and 216 of FIG. 2), tools/software 508 of the data sources 410, a control system 520 (e.g., information system 104 of FIG. 1), and an API 524 that, in some implementations, communicates over a data communication network 502, e.g., a local area network (LAN), a wide area network (WAN), the Internet, a mobile network, or a combination thereof.

Example environment 500 is configured to use image and sensor data to generate a stage anchor map comprising a standard-format for use via multiple differing devices (e.g., data sources 510) that may be associated with different types of tools/software 508 such as, inter alia, different survey tools 516, different file formats 514, and different application 512 types (e.g., different sensors, different operating systems, different captured-image formats, etc.). In some implementations, the stage anchor map may identify positions of elements of a 3D scene (e.g., an extended reality (XR) environment) such as, inter alia, stage anchors as described with respect to FIGS. 3 and 4, supra.

In some implementations, multiple recording devices (e.g., multiple different camera devices such as data sources 510) may be localized within a 3D scene during a filming session by comparing sensor data of the multiple recording devices to a map of the 3D scene. In some implementations, a map of the 3D scene may be generated based on data such as image data captured by data sources 510. The captured data is converted to an intermediate standardized format and a process such as an API 524 may be configured to convert the intermediate format data into a final standardized format such as, for example, a SLAM map that identifying stage anchors as described with respect to FIGS. 3 and 4. In some implementations, the intermediate format data may include image data, camera data, or any other data usable by API 524 to determine 3D locations of stage anchors based on images from data sources 510. In some implementations, image data may include, inter alia, RGB data, greyscale data, depth data, etc. In some implementations, camera data may include, inter alia, a position or rotation of a camera for each picture, camera information such as a fish-eye perspective image, distortion, etc.

In some implementations, a final stage anchor map is generated such that it does not include (and is not based on) a 3D mapping of an any of data sources 510 and therefore does not expose (to any of other data sources 510) the image capturing device's (one of data sources 510) platform's 3D information or processes. Therefore, the image capturing device will only produce intermediate data and use API 524 to generate final, sharable mapping data used for localization.

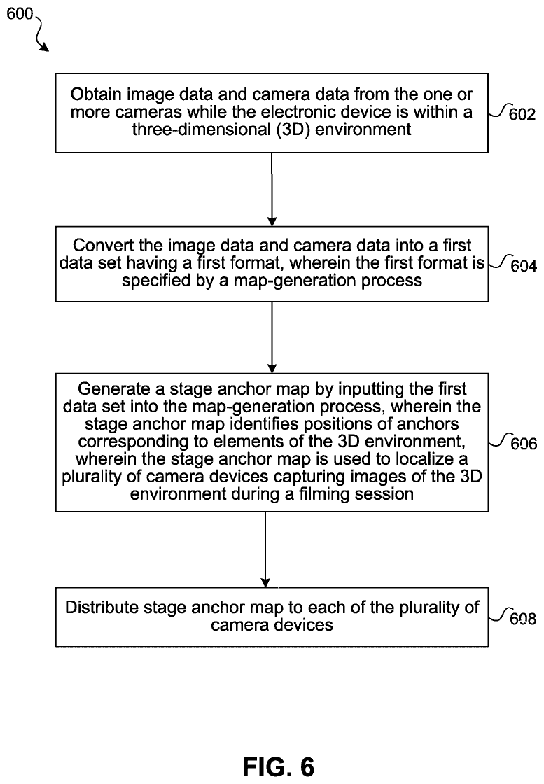

FIG. 6 is a flowchart representation of an exemplary method 600 that uses image and sensor data to generate a standard-format stage anchor map identifying positions of elements of a 3D scene, in accordance with some implementations. In some implementations, the method 600 is performed by a device, such as a camera, mobile device, desktop, laptop, or server device. In some implementations, the device has a screen for displaying images and/or a screen for viewing stereoscopic images such as a head-mounted display (HMD such as e.g., device 216 of FIG. 2). In some implementations, the method 600 is performed by processing logic, including hardware, firmware, software, or a combination thereof. In some implementations, the method 600 is performed by a processor executing code stored in a non-transitory computer-readable medium (e.g., a memory). Each of the blocks in the method 600 may be enabled and executed in any order.

At block 602, the method 600 obtains image data and camera data from a plurality of cameras while the electronic device is within a three-dimensional (3D) environment. For example, camera and image data may be retrieved from electronic devices 205, 215a, 215b, 215c and 216 as described with respect to FIG. 2.

In some implementations, each of the plurality of camera devices may be a different type of device(s) such as, inter alia, mobile devices, tablet devices, HMDs, stand-alone video camera devices, and wall-mounted camera devices as described with respect to FIG. 2.

In some implementations, each of the plurality of camera devices may be a device having different types of: sensors; operating; systems or captured-image formats as described with respect to FIG. 5.

In some implementations, image data may include RGB image data, greyscale image data, depth sensor image data, etc.

In some implementations, camera data may include image-specific 3D camera position data or image specific 3D camera rotation data.

In some implementations, camera data may include camera attribute data or camera intrinsic data such as, inter alia, a fish eye perspective image, distortion, etc.

At block 604, the method 600 converts the image data and camera data into a first data set having a first format that may be specified by a map-generation process as described with respect to FIG. 3. In some implementations, the map-generation process may be a map-generation API that exposes a function for generating stage anchor maps. For example, API 524 as described with respect to FIG. 5. In some implementations, the first data set may include the image data or camera data converted into a different format.

At block 606, the method 600 generates a stage anchor map (e.g., map 320 as illustrated in FIG. 3) by inputting the first data set into the map-generation process or API. The stage anchor map may identify positions of anchors (e.g., objects/SLAM features) corresponding to elements of the 3D environment. In some implementations, the stage anchor map may be used to localize a plurality of camera devices capturing images of the 3D environment during a filming session.

In some implementations, the electronic device may separately generate 3D information about the 3D environment. In some implementations, the stage anchor map may exclude the separately-generated 3D information.

In some implementations, a stage anchor map may exclude information about a platform-specific 3D mapping process used by the electronic device.

At block 608, the method 600 enables the electronic device to distribute the stage anchor map (or copies of) to each of the plurality camera devices (e.g., electronic devices 205, 215a, 215b, 215c and 216 as described with respect to FIG. 2) to be used by applications of the plurality of camera devices. For example, applications of the plurality of camera devices may enable a process for querying the stage anchor map to, inter alia, generate a SLAM map identifying the (stage) anchors to perform a localization process for localizing each of the plurality of camera devices, obtain light probes, upload information to the stage anchor map for updates, etc.

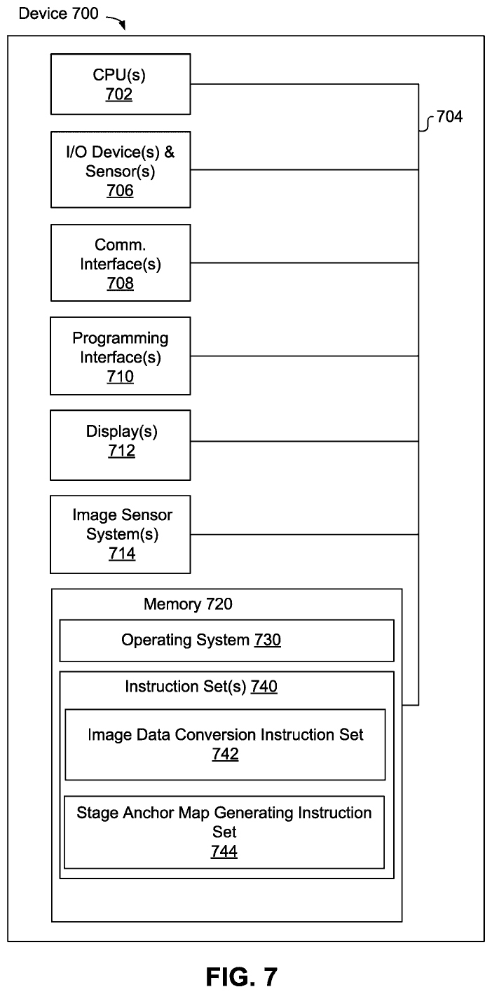

FIG. 7 is a block diagram of an example device 700. Device 700 illustrates an exemplary device configuration for electronic devices 105, 112, 115a, 115b, 115c, 115d, and 116 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 700 includes one or more processing units 702 (e.g., microprocessors, ASICs, FPGAs, GPUs, CPUs, processing cores, and/or the like), one or more input/output (I/O) devices and sensors 706, one or more communication interfaces 708 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 710, one or more displays 712, one or more interior and/or exterior facing image sensor systems 714, a memory 720, and one or more communication buses 704 for interconnecting these and various other components.

In some implementations, the one or more communication buses 704 include circuitry that interconnects and controls communications between system components. In some implementations, the one or more I/O devices and sensors 706 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 712 are configured to present a view of a physical environment or a graphical environment to the user. In some implementations, the one or more displays 712 are configured to present content (determined based on a determined user/object location of the user within the physical environment) to the user. In some implementations, the one or more displays 712 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more displays 712 correspond to diffractive, reflective, polarized, holographic, etc. waveguide displays. In one example, the device 700 includes a single display. In another example, the device 700 includes a display for each eye of the user.

In some implementations, the one or more image sensor systems 714 are configured to obtain image data that corresponds to at least a portion of the physical environment 105. For example, the one or more image sensor systems 714 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 714 further include illumination sources that emit light, such as a flash. In various implementations, the one or more image sensor systems 714 further include an on-camera image signal processor (ISP) configured to execute a plurality of processing operations on the image data.

In some implementations, sensor data may be obtained by device(s) (e.g., devices 105 and 110 of FIG. 1) during a scan of a room of a physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, IMU, etc.). In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room).

In some implementations, sensor data may be positioning information, some implementations include a VIO to determine equivalent odometry information using sequential camera images (e.g., light intensity image data) and motion data (e.g., acquired from the IMU/motion sensor) to estimate the distance traveled. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In some implementations, the device 700 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 700 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 700.

The memory 720 includes high-speed random-access memory, such as DRAM, SRAM, DDR RAM, or other random-access solid-state memory devices. In some implementations, the memory 720 includes non-volatile memory, such as one or more magnetic disk storage devices, optical disk storage devices, flash memory devices, or other non-volatile solid-state storage devices. The memory 720 optionally includes one or more storage devices remotely located from the one or more processing units 702. The memory 720 includes a non-transitory computer readable storage medium.

In some implementations, the memory 720 or the non-transitory computer readable storage medium of the memory 720 stores an optional operating system 730 and one or more instruction set(s) 740. The operating system 730 includes procedures for handling various basic system services and for performing hardware dependent tasks. In some implementations, the instruction set(s) 740 include executable software defined by binary information stored in the form of electrical charge. In some implementations, the instruction set(s) 740 are software that is executable by the one or more processing units 702 to carry out one or more of the techniques described herein.

The instruction set(s) 740 includes an image data conversion instruction set 742 and a stage anchor map generating instruction set 744. The instruction set(s) 740 may be embodied as a single software executable or multiple software executables.

The image data conversion instruction set 742 is configured with instructions executable by a processor to convert image data and camera data into a data set having a format is specified by a map-generation process such as an API.

The stage anchor map generating instruction set 744 is configured with instructions executable by a processor to generate a stage anchor map by inputting the data set into the map-generation process.

Although the instruction set(s) 740 are shown as residing on a single device, it should be understood that in other implementations, any combination of the elements may be located in separate computing devices. Moreover, FIG. 7 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at an electronic device having a processor and one or more cameras:
obtaining image data and camera data from a plurality camera devices while the electronic device is within a three-dimensional (3D) environment;
converting the image data and camera data into a first data set having a first format, wherein the first format is specified by a map-generation process; and
generating a stage anchor map by inputting the first data set into the map-generation process, wherein the stage anchor map identifies positions of anchors corresponding to elements of the 3D environment, wherein the stage anchor map is used to localize a plurality of camera devices capturing images of the 3D environment during a filming session.

2. The method of claim 1, wherein the plurality of camera devices comprise different types of devices, the different types of devices comprising at least two of mobile devices, tablet devices, head-mounted devices (HMDs), stand-alone video camera devices, and wall-mounted camera devices.

3. The method of claim 1, wherein the plurality of camera devices comprise devices having different types of: sensors; operating systems; or captured-image formats.

4. The method of claim 1, wherein the stage anchor map is used to localize the plurality of camera devices via matching elements depicted in images captured by the plurality of camera devices with the anchors of the stage anchor map.

5. The method of claim 1, wherein the map-generation process is a map-generation application programming interface (API) that exposes a function for generating stage anchor maps.

6. The method of claim 1, wherein the image data comprises RGB image data, greyscale image data, depth sensor image data.

7. The method of claim 1, wherein the camera data comprises image-specific 3D camera position data or image specific 3D camera rotation data.

8. The method of claim 1, wherein the camera data comprises camera attribute data or camera intrinsic data.

9. The method of claim 1, wherein the first data set comprises the image data or the camera data converted into a different format.

10. The method of claim 1, wherein:
the electronic device separately generates 3D information about the environment; and
the stage anchor map excludes the separately-generated 3D information.

11. The method of claim 1, wherein the stage anchor map excludes information about a platform-specific 3D mapping process used by the electronic device.

12. The method of claim 1, further comprising:
distributing the stage anchor map to each of the plurality of camera devices, wherein the distributed stage anchor map is queried by each of the plurality of camera devices.

13. The method of claim 12, wherein the distributed stage anchor map is queried by each of the plurality of camera devices to generate a SLAM map to localize each of the plurality of camera devices.

14. The method of claim 12, wherein the distributed stage anchor map is queried by each of the plurality of camera devices to obtain light probes.

15. The method of claim 12, wherein the distributed stage anchor map is queried by each of the plurality of camera devices to upload updated images for updating the distributed stage anchor map.

16. An electronic device comprising:
a non-transitory computer-readable storage medium;
one or more cameras; and
one or more processors coupled to the non-transitory computer-readable storage medium, wherein the non-transitory computer-readable storage medium comprises program instructions that, when executed on the one or more processors, cause the electronic device to perform operations comprising:
obtaining image data and camera data from the one or more cameras while the electronic device is within a three-dimensional (3D) environment;
converting the image data and camera data into a first data set having a first format, wherein the first format is specified by a map-generation process; and
generating a stage anchor map by inputting the first data set into the map-generation process, wherein the stage anchor map identifies positions of anchors corresponding to elements of the 3D environment, wherein the stage anchor map is used to localize a plurality of camera devices capturing images of the 3D environment during a filming session.

17. The electronic device of claim 16, wherein the plurality of camera devices comprise different types of devices, the different types of devices comprising at least two of mobile devices, tablet devices, head-mounted devices (HMDs), stand-alone video camera devices, and wall-mounted camera devices.

18. The electronic device of claim 16, wherein the plurality of camera devices comprise devices having different types of: sensors; operating systems; or captured-image formats.

19. The electronic device of claim 16, wherein the stage anchor map is used to localize the plurality of camera devices via matching elements depicted in images captured by the plurality of camera devices with the anchors of the stage anchor map.

20. A non-transitory computer-readable storage medium, storing program instructions executable by one or more processors to perform operations comprising:
at a wearable electronic device having a processor and one or more cameras:
obtaining image data and camera data from the one or more cameras while the electronic device is within a three-dimensional (3D) environment;
converting the image data and camera data into a first data set having a first format, wherein the first format is specified by a map-generation process; and
generating a stage anchor map by inputting the first data set into the map-generation process, wherein the stage anchor map identifies positions of anchors corresponding to elements of the 3D environment, wherein the stage anchor map is used to localize a plurality of camera devices capturing images of the 3D environment during a filming session.
